(19) United States
(12) Patent Application Publication
(10) Pub. No.: US 2026/0147355 A1
(43) Pub. Date: May 28, 2026

(54) Real-Time Path Generation Method and System for Corner Turning of Robot

(71) Applicants: Hyundai Motor Company, Seoul (KR); Kia Corporation, Seoul (KR)

(72) Inventor: Hwanhee Lee, Hwaseong-Si (KR)

(21) Appl. No.: 19/247,355

(22) Filed: Jun. 24, 2025

(30) Foreign Application Priority Data
Nov. 25, 2024 (KR) 10-2024-0169287

(51) Int. Cl. G05D 1/644; G05D 1/246; G05D 1/622

(52) U.S. Cl. CPC G05D 1/644; G05D 1/2464; G05D 1/622

(57) ABSTRACT

A method may comprise, based on a grid map and information regarding an obstacle detected by a sensor of the robot, generating a cost map for surrounding areas of a robot, generating, based on the cost map, a shortest avoidance path from a current position of the robot to a destination such that the shortest avoidance path bypasses the obstacle, detecting a blocked region that is outside a sensing range of the sensor at the current position of the robot, detecting, based on the shortest avoidance path and the blocked region, a corner entry point, generating, based on the shortest avoidance path and the corner entry point, a turning region securing path, determining weight values, generating an interpolation path, generating a final path, outputting a signal indicating the final path, and controlling, based on the signal, driving of the robot.

### CROSS-REFERENCE TO RELATED APPLICATION

This application claims the benefit of priority to Korean Patent Application No. 10-2024-0169287 filed in the Korean Intellectual Property Office on Nov. 25, 2024, the entire contents of which are incorporated herein by reference.

### TECHNICAL FIELD

The present disclosure relates to a real-time path generation method and system for corner turning of a robot.

### BACKGROUND

The matters described in this Background section are only for enhancement of understanding of the background of the disclosure, and should not be taken as acknowledgment that they correspond to prior art already known to those skilled in the art.

Utilization of mobile robots such as indoor/outdoor delivery robots, service robots, and patrol robots, has been increasing. Most of these mobile robots may perform tasks based on an autonomous driving technology. In order for a mobile robot to autonomously drive from a current location to a destination location, a real-time path planning technology capable of actively avoiding obstacles is desirable. Furthermore, there is a growing need for a technology that may prevent collisions with obstacles located in regions that are difficult for sensors to detect in advance, such as when turning a corner.

When attempting to turn a corner, a mobile robot that is not programmed with a specialized corner turning strategy follows a path that turns relatively close to the corner in order to take the shortest route. In this case, it may be difficult to secure safety with respect to an object approaching from the opposite side of the corner, which is a region that is difficult for a sensor to detect in advance.

In one example of a robot corner turning method, a robot may decelerate or temporarily stop and then resume driving when turning a corner. However, such method may not fundamentally prevent collisions with objects approaching from the opposite side of the corner.

In another example of a robot corner turning method, a path that makes a large turn at each corner may be defined in advance, and a robot may follow the path. However, such method may require that a path be predefined for all corners and lack flexibility in responding to environments that change moment by moment. In particular, it may be difficult to handle situations where an unexpected obstacle exists along the predefined path.

### SUMMARY

The present disclosure attempts to provide real-time path generation method and system for corner turning of a robot capable of securing safety for objects approaching from an opposite side of a corner by generating a path that makes a large turn around the corner based on real-time obstacle information.

According to the present disclosure, a method performed by an apparatus of a robot, the method may comprise based on a grid map and information regarding an obstacle detected by a sensor of the robot, generating a cost map for surrounding areas of the robot, wherein the surrounding areas are within a threshold distance from the robot, generating, based on the cost map, a shortest avoidance path from a current position of the robot to a destination such that the shortest avoidance path bypasses the obstacle, detecting a blocked region that is outside a sensing range of the sensor at the current position of the robot, detecting, based on the shortest avoidance path and the blocked region, a corner entry point, generating, based on the shortest avoidance path and the corner entry point, a turning region securing path, determining weight values for the shortest avoidance path and the turning region securing path, generating an interpolation path, wherein the interpolation path is based on the shortest avoidance path, the turning region securing path, and the weight values, generating, based on the shortest avoidance path and the interpolation path, a final path, outputting a signal indicating the final path, and controlling, based on the signal, driving of the robot.

The method, wherein the detecting the corner entry point may comprise checking, for each node included in the shortest avoidance path sequentially from the current position of the robot to the destination, whether the node belongs to a sensor detection region or a blocked region, identifying, as the corner entry point, a first node that transitions from the sensor detection region to the blocked region, and detecting a turning direction associated with entering a corner.

The method, wherein the generating the turning region securing path may comprise determining, based on the turning direction, a search direction of a turning region, and searching, for each node included in the shortest avoidance path sequentially from the current position of the robot to the destination, for a point in the search direction where a safety securing distance is satisfied within a search distance, and setting the point as a turning region securing point, wherein the safety securing distance is a distance to be separated from the obstacle.

The method, wherein the determining the search direction may comprise, for each node included in the shortest avoidance path, determining the search direction as a direction opposite to the turning direction when entering the corner, the direction being among directions orthogonal to a tangent line of the shortest avoidance path.

The method, wherein the safety securing distance is preset or varies based on a property of the obstacle.

The method, wherein the search distance is a preset maximum search distance. The method, wherein the search distance from a current node is determined based on a sum of a preset number of cells and a previous search distance from a previous node, wherein the preset number of cells is a natural number, and wherein the sum is limited so as not to exceed a preset maximum search distance.

The method, wherein the determining the weight values may comprise selecting a peak point on the shortest avoidance path and a corresponding peak point on the turning region securing path, assigning a weight value of 1 to the corresponding peak point on the turning region securing path and assigning a weight value of 0 to the peak point on the shortest avoidance path, assigning a weight value of 0 to a node of the turning region securing path at the current position of the robot and to a node of the turning region securing path at the destination, and assigning a weight value of 1 to a node of the shortest avoidance path at the current position of the robot and to a node of the shortest avoidance path at the destination, assigning, to nodes along the turning region securing path, weight values that increase from 0 at the current position of the robot to 1 at the corresponding peak point and weight values that decrease from 1 at the corresponding peak point to 0 at the destination, and assigning, to nodes along the shortest avoidance path, weight values that decrease from 1 at the current position of the robot to 0 at the peak point and weight values that increase from 0 at the peak point to 1 at the destination.

The method, wherein the peak point on the shortest avoidance path and the corresponding peak point on the turning region securing path are selected as a center point of the shortest avoidance path and a center point of the turning region securing path, respectively, or the corner entry point and a corresponding entry point on the turning region securing path, respectively.

The method, wherein the interpolation path is generated based on a sum of a weighted path value associated with the turning region securing path, and a weighted path value associated with the shortest avoidance path.

According to the present disclosure, an apparatus of a robot, the apparatus may comprise a processor, and a memory storing at least one instruction that, when executed by the processor communicating with the memory, is configured to cause the apparatus to detect, using a sensor of the robot, sensor data within a field of view of the sensor, and based on a grid map and the sensor data, generate a cost map for surrounding areas of the robot, wherein the surrounding areas are within a threshold distance from the robot, generate, based on the cost map, a shortest avoidance path from a current position of the robot to a destination such that the shortest avoidance path bypasses an obstacle, detect a blocked region that is outside the field of view at the current position of the robot, detect, based on the shortest avoidance path and the blocked region, a corner entry point, generate, based on the shortest avoidance path and the corner entry point, a turning region securing path, determine weight values for the shortest avoidance path and the turning region securing path, generate an interpolation path, wherein the interpolation path is based on the shortest avoidance path, the turning region securing path, and the weight values, and generate, based on the shortest avoidance path and the interpolation path, a final path, output a signal indicating the final path, and control, based on the signal, movements of the robot.

The apparatus, wherein the at least one instruction, when executed by the processor communicating with the memory, is configured to cause the apparatus to detect the corner entry point by checking, for each node included in the shortest avoidance path sequentially from the current position of the robot to the destination, whether the node belongs to a sensor detection region or a blocked region, identifying, as the corner entry point, a first node that transitions from the sensor detection region to the blocked region, and detecting a turning direction associated with entering a corner.

The apparatus, wherein the at least one instruction, when executed by the processor communicating with the memory, is configured to cause the apparatus to generate the turning region securing path by determining, based on the turning direction, a search direction of a turning region, and searching, for each node included in the shortest avoidance path sequentially from the current position of the robot to the destination, for a point in the search direction where a safety securing distance is satisfied within a search distance, and setting the point as a turning region securing point, wherein the safety securing distance is a distance to be separated from the obstacle.

The apparatus, wherein the at least one instruction, when executed by the processor communicating with the memory, is configured to cause the apparatus to, for each node included in the shortest avoidance path, determine the search direction as a direction opposite to the turning direction when entering the corner, the direction being among directions orthogonal to a tangent line of the shortest avoidance path.

The apparatus, wherein the safety securing distance is preset or varies based on a property of the obstacle. The apparatus, wherein the search distance is a preset maximum search distance.

The apparatus, wherein the at least one instruction, when executed by the processor communicating with the memory, is configured to cause the apparatus to determine the search distance from a current node based on a sum of a preset number of cells and a previous search distance from a previous node, wherein the preset number of cells is a natural number, and wherein the sum is limited so as not to exceed a preset maximum search distance.

The apparatus, wherein the at least one instruction, when executed by the processor communicating with the memory, is configured to cause the apparatus to determine the weight values by selecting a peak point on the shortest avoidance path and a corresponding peak point on the turning region securing path, assigning a weight value of 1 to the corresponding peak point on the turning region securing path and assigning a weight value of 0 to the peak point on the shortest avoidance path, assigning a weight value of 0 to a node of the turning region securing path at the current position of the robot and to a node of the turning region securing path at the destination, and assigning a weight value of 1 to a node of the shortest avoidance path at the current position of the robot and to a node of the shortest avoidance path at the destination, assigning, to nodes along the turning region securing path, weight values that increase from 0 at the current position of the robot to 1 at the corresponding peak point and weight values that decrease from 1 at the corresponding peak point to 0 at the destination, and assigning, to nodes along the shortest avoidance path, weight values that decrease from 1 at the current position of the robot to 0 at the peak point and weight values that increase from 0 at the peak point to 1 at the destination.

According to the present disclosure, a method performed by an apparatus of a vehicle, the method may comprise receiving spatial data representing an environment of the vehicle, including information associated with obstacles, generating, based on the spatial data, a path from a current position of the vehicle to a destination, identifying a region with limited sensing coverage relative to a sensor of the vehicle, determining, based on the path and the region, a candidate transition point, generating, based on the candidate transition point and the information associated with the obstacles, a secondary path, determining respective weight values for the path and the secondary path, generating an interpolated path, wherein the interpolated path is based on the path, the secondary path, and the weight values, and outputting, based on the interpolated path, a signal indicating a final path, and controlling, based on the signal, autonomous driving of the vehicle.

The method, wherein the generating of the secondary path may comprise adjusting a spacing distance from at least one of the obstacles based on a property of the at least one of the obstacles, and wherein the vehicle may comprise a robot.

Other effects that may be obtained or are predicted from an example of the present disclosure will be explicitly or implicitly described in a detailed description of the example of the present disclosure. For example, various effects that are predicted from an example of the present disclosure will be described in the following detailed description.

### BRIEF DESCRIPTION OF THE DRAWINGS

Examples of the present disclosure may be better understood with reference to the following description taken in conjunction with the accompanying drawings, in which like reference numerals denote identical or functionally similar elements:

FIG. 1 shows an example of a real-time path generation system for corner turning of a robot according to an example of the present disclosure;

FIG. 2 shows an example of an occupancy grid map;

FIG. 3 shows an example of a cost map;

FIG. 4 shows exemplary generation of a shortest avoidance path based on a cost map;

FIG. 5 shows exemplary detection of a corner entry point based on the shortest avoidance path of FIG. 4;

FIG. 6 shows exemplary generation of a turning region securing path based on the shortest avoidance path of FIG. 4 when a safety securing distance is three cells;

FIG. 7 is a partially enlarged view of FIG. 6;

FIG. 8 shows exemplary generation of a turning region securing path based on the shortest avoidance path of FIG. 4 when a safety securing distance is two cells;

FIG. 9 is a partially enlarged view of FIG. 8;

FIG. 10 shows exemplary generation of a turning region securing path based on a safety securing distance according to a type of an obstacle and the shortest avoidance path of FIG. 4;

FIG. 11 shows exemplary generation of a turning region securing path by adjusting a search distance in FIG. 10;

FIG. 12 shows an example of determining a weight value based on the turning region securing path of FIG. 6;

FIG. 13 shows exemplary generation of an interpolation path based on the weight value determined in FIG. 12; and

FIG. 14 shows an example of a real-time path generation method for corner turning of a robot according to another example of the present disclosure.

It is to be understood that the drawings referenced above are not necessarily drawn to scale, and present somewhat simplified representations of various preferred features illustrating the basic principles of the present disclosure. Specific design features of the present disclosure as included herein, including, for example, specific dimensions, orientations, locations, and shapes will be determined in part by the particularly intended application and use environment.

### DETAILED DESCRIPTION

Terms used herein are for describing particular examples and are not intended to limit the present disclosure. As used herein, singular forms are intended to include plural forms as well, unless the context clearly indicates otherwise. It is to be further understood that the terms “includes” and/or “including” used in the present specification specify the presence of stated features, integers, steps, operations, elements, and/or components, but do not preclude the presence or addition of one or more other features, integers, steps, operations, components, and/or combinations thereof. As used herein, the term “and/or” includes any or all combinations of one or more of the associated listed items.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

The term “robot” or other similar terms as used herein may include general land-mobile robots such as passenger cars including sports utility vehicles (SUVs), buses, trucks, various commercial vehicles, marine-mobile robots such as various boats and ships, aerial-mobile robots such as aircraft and drones, and any object that may be moved by receiving power from a power source. It is to be understood that the term “robot” or other similar terms as used herein may include hybrid powered robots, electric powered robots, plug-in hybrid powered robots, hydrogen powered robots, and other alternative fuel (for example, fuels derived from resources other than petroleum) robots. As used herein, the hybrid powered robots may include robots having two or more power sources, for example, gasoline powered and electric powered robots. A robot according to an example of the present disclosure may include a robot that is somewhat autonomously driven as well as a robot that is fully autonomous or is driven in an automated manner.

In addition, it is understood that one or more of the following methods or the aspects thereof may be executed by at least one controller. The term “controller” may refer to a hardware device including a memory and a processor. The memory is configured to store program commands, and the processor is specially programmed so as to execute program commands to perform one or more processes described in more detail below. The controller may control operations of units, modules, components, devices, or similar matters as described herein. Further, it is understood that the following methods may be executed by a device including the controller together with one or more other components as recognized by those skilled in the art.

Further, the controller according to the present disclosure may be implemented as a non-transitory computer-readable recording medium including program commands executable by a processor. Examples of the computer-readable recording medium may include a read only memory (ROM), a random access memory (RAM), a compact disc (CD) ROM, magnetic tapes, floppy discs, flash drives, smart cards, and optical data storage devices, but the computer-readable recording medium is not limited thereto. The computer-readable recording medium may also be distributed across a computer network such that program commands are stored and executed by a distributed method such as a telematics server or a controller area network (CAN).

In the present disclosure, the “module” or “unit” may be realized as a processor and a memory. The “processor” should be widely construed to include a general-purpose processor, a central processing unit (CPU), a microprocessor, a digital signal processor (DSP), a microcontroller, a state machine, or the like. In some environments, the “processor” may refer to an application-specific integrated circuit (ASIC), a programmable logic device (PLD), or a field-programmable gate array (FPGA), and the like. For example, the “processor” may refer to a combination of processing devices such as a combination of a DSP and a microprocessor, a combination of a plurality of microprocessors, a combination of one or more microprocessors combined with a DSP core, or any other such combination. Moreover, the “memory” should be widely construed to include any electronic component capable of storing electronic information. The “memory” may refer to various types of processor-readable medium such as a random access memory (RAM), a read only memory (ROM), a non-volatile random access memory (NVRAM), a programmable read only memory (PROM), an erasable programmable read only memory (EPROM), an electrically erasable programmable read only memory (EEPROM), a flash memory, a magnetic or optical data storage device, and registers. When the processor can read information from a memory and/or record the information in the memory, the memory may be in a state of electronic communication with a processor. Memory integrated into a processor is in a state of electronic communication with the processor.

The one or more features described herein may be provided as a computer program stored in a computer-readable recording medium in order to be executed on a computer. The medium may either continuously store a computer-executable program or temporarily store the program for execution or download. Furthermore, the medium may be a variety of recording or storage means in the form of a single hardware device or multiple combined hardware devices, and is not limited to media directly connected to some computer system but may also be distributed across a network. Examples of such media include magnetic media such as a hard disk, a floppy disk, or a magnetic tape, optical recording media such as a CD-ROM or a DVD, magneto-optical media such as a floptical disk, and a ROM, RAM, or flash memory, among others, configured to store program instructions. Additional examples of such media include media or storage media that are managed by an app store that distributes applications or by various other sites or servers that provide or distribute software.

In a hardware implementation, processing units used for performing the techniques may be implemented within one or more ASICs, DSPs, digital signal processing devices, programmable logic devices, field-programmable gate arrays, processors, controllers, microcontrollers, microprocessors, electronic devices, or computers or combinations thereof designed to perform the functions described in the present disclosure. An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein.

One or more features associated with autonomous driving control may be activated based on configured autonomous driving control setting(s) (e.g., based on at least one of: an autonomous driving classification, a selection of an autonomous driving level for a vehicle, etc.). Based on one or more features (e.g., feature of corner turning) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., feature of corner turning) described herein.

One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., feature of corner turning) described herein.

Minimum risk maneuver (MRM) operation(s) may also be controlled, for example, based on one or more features (e.g., feature of corner turning) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., feature of corner turning) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane. The driving control apparatus may identify or determine a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., feature of corner turning) described herein. An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, etc.).

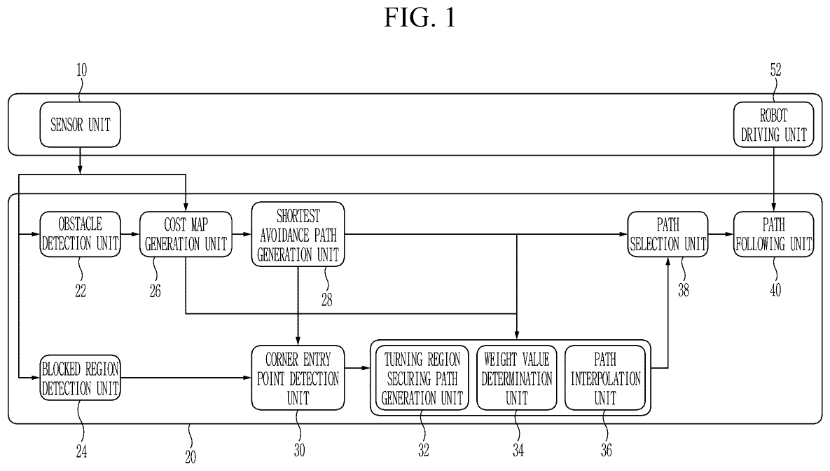

FIG. 1 shows an example of a real-time path generation system for corner turning of a robot according to an example of the present disclosure.

As illustrated in FIG. 1, a real-time path generation system for corner turning of a robot 50 according to an example of the present disclosure may include a sensor unit 10, a controller 20, and a robot 50.

The sensor unit 10 may be mounted on the robot 50 and may include any sensor capable of detecting an obstacle within a field of view, such as a light detection and ranging (LIDAR), a camera, an ultrasonic sensor, or a radar detection and ranging (radar) (e.g., LiDAR, stereo camera, ultrasonic sensor, or millimeter-wave radar, etc.). Here, the term “obstacle” or other similar terms may mean an object such as a building, a wall, or a person that impedes movement of the robot 50 or that the robot 50 may not pass through (e.g., walls, poles, pedestrians, or vehicles, etc.). The term “obstacle” or other similar terms may mean an object that occupies a physical space and is within a range of a height of the robot 50. The sensor unit 10 may be connected so as to transmit data to the controller 20 and may transmit sensor data 68 detected within the field of view to the controller 20.

The controller 20 may receive the sensor data 68 from the sensor unit 10, generate a path for autonomous driving of the robot 50 based on the sensor data 68, and control the autonomous driving of the robot 50 according to the generated path (e.g., by planning, selecting, and executing navigation routes in real time based on obstacle and environment information, etc.). To this end, the controller may be implemented by one or more processors operating according to a set program, and the set program may be programmed to perform each step of a real-time path generation method for corner turning of the robot 50 according to an example of the present disclosure (e.g., path generation, obstacle avoidance, and trajectory adjustment, etc.). The controller 20 may include an obstacle detection unit 22, a cost map generation unit 26, a shortest avoidance path generation unit 28, a blocked region detection unit 24, a corner entry point detection unit 30, a turning region securing path generation unit 32, a weight value determination unit 34, a path interpolation unit 36, a path selection unit 38, and a path following unit 40 (e.g., units for sensing, path planning, decision-making, or motion control, etc.).

The obstacle detection unit 22 may detect the obstacle based on the sensor data 68 received from the sensor unit 10, and transmit information regarding the detected obstacle to the cost map generation unit 26 (e.g., providing obstacle presence, type, position, or size information for map updating, etc.). The information regarding the obstacle may include a presence, a type, a position, a size, a speed, or the like of the obstacle. The obstacle detection unit 22 may store an obstacle detection logic that detects the obstacle from the sensor data 68, and the obstacle detection logic may be a point-cloud-based logic, an image-based logic, a deep-learning-based logic, a sensor-fusion-based logic, a LiDAR-intensity-based logic, a radar-reflection-based logic, or the like (e.g., point cloud processing, image classification, deep learning models, sensor fusion algorithms, or radar analysis, etc.). The obstacle detection logic is not particularly limited, and an appropriate obstacle detection logic known to those skilled in the art may be used.

The cost map generation unit 26 may store a grid map, and the cost map generation unit 26 may generate an occupancy grid map 60 based on the grid map and the information regarding the obstacle transmitted from the obstacle detection unit 22 (e.g., updating cell statuses based on real-time obstacle detection to reflect the current environment, etc.). In addition, the cost map generation unit 26 may be configured to generate a cost map 64 for surroundings of the robot 50 based on the occupancy grid map 60 and the information regarding the obstacle (e.g., by assigning higher costs near obstacles and lower costs in open spaces, etc.).

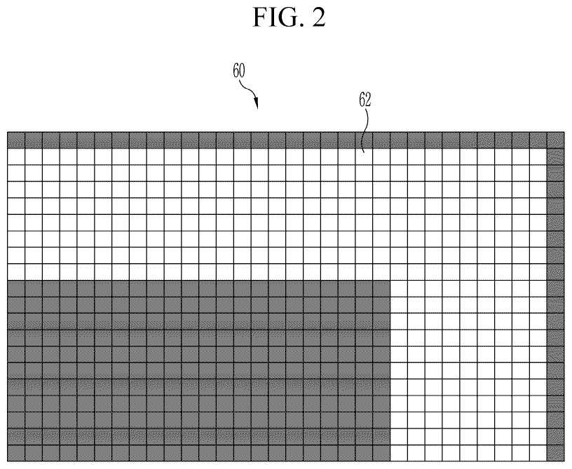

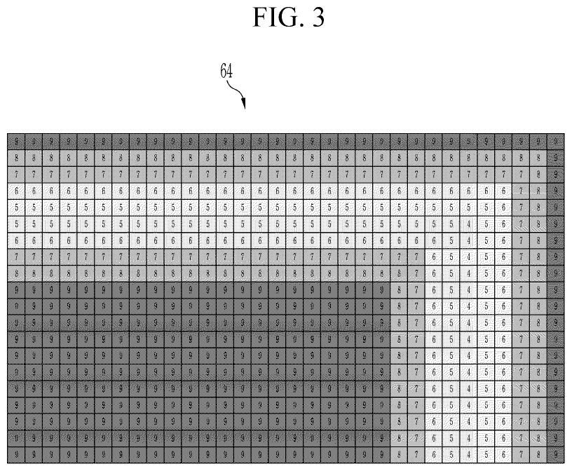

FIG. 2 shows an example of the occupancy grid map, and FIG. 3 shows an example of the cost map. The grid map may refer to a map that divides a physical space where the robot 50 may drive, such as the ground or a floor, into a plurality of cells 62 of the same size (e.g., 0.1 meters×0.1 meters, 0.5 meters×0.5 meters, or other uniform divisions, etc.). The occupancy grid map 60 may refer to a map that displays (for example, in dark gray), records, or stores occupancy by the obstacle on the grid map based on the information regarding the obstacle as illustrated in FIG. 2 (e.g., marking cells as occupied or free depending on obstacle detection, etc.). The cost map 64 may refer to a map that displays, records, or stores a cost required for the robot 50 to pass through the cell 62 as illustrated in FIG. 3 (e.g., assigning higher traversal costs near obstacles and lower costs in open spaces, etc.).

For example, as illustrated in FIG. 3, the cell 62 occupied by the obstacle may be assigned the highest cost of 9, and the cost assigned to the cell 62 may decrease linearly as the distance from the occupied region increases (e.g., cost value decreases by a fixed amount per grid step, etc.). Alternatively, the cell 62 occupied by the obstacle may be assigned 9, and the cost assigned to the cell 62 may decrease nonlinearly as the distance from the occupied region increases (e.g., exponential decay, quadratic reduction, or logarithmic decay, etc.). Alternatively, the cost may be assigned to the cell 62 based on not only the distance to the obstacle but also the type of the obstacle, heat map information, environmental priority levels, or the like (e.g., distinguishing between human, wall, vehicle, or furniture, etc.). However, a method of assigning the cost to each cell 62 of the cost map 64 is not limited to the illustrated method, and a cost assignment method deemed appropriate by those skilled in the art may be adopted.

The shortest avoidance path generation unit 28 may generate a shortest avoidance path 70 along which a destination 66 may be reached from the current position of the robot 50 while avoiding the obstacle, by using a path generation algorithm based on the cost map 64 generated by the cost map generation unit 26. The path generation algorithm is not particularly limited, and may include at least one of various path generation algorithms known to those skilled in the art (e.g., An algorithm, Dijkstra's algorithm, Jump Point Search (JPS), Rapidly-exploring Random Tree (RRT), or Hybrid A, etc.).

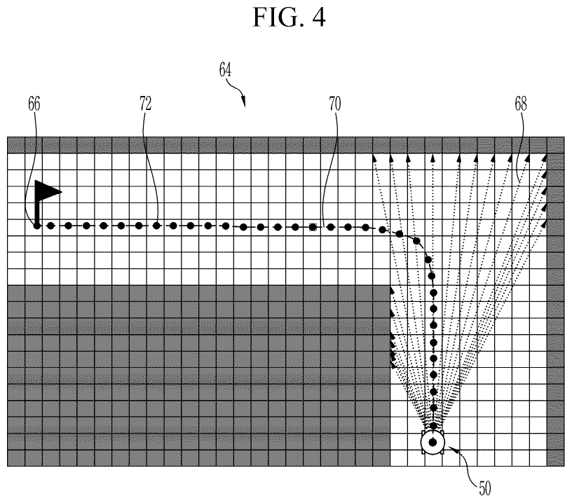

FIG. 4 shows exemplary generation of the shortest avoidance path based on the cost map (e.g., showing how an optimal path is determined while factoring in obstacle proximity and traversal cost, etc.). For example, as illustrated in FIG. 4, the shortest avoidance path generation unit 28 may generate, based on the cost map 64, the shortest avoidance path 70 along which the robot 50 may reach the destination 66 while avoiding the obstacle at the lowest cost (e.g., minimizing total path cost while maintaining safe clearance from obstacles, etc.). The shortest avoidance path 70 may include a plurality of nodes 72 that the robot 50 needs to pass through, and the plurality of nodes 72 may include a node 72 corresponding to the current position of the robot 50, a node 72 corresponding to the destination 66, and at least one node 72 between the nodes 72 (e.g., intermediate waypoints or reorientation points, etc.). The plurality of nodes 72 included in the shortest avoidance path 70 may be set such that a distance between neighboring nodes 72 is the same (e.g., 0.1 meters, 0.2 meters, or 0.5 meters, etc.), or one node 72 may be disposed for each cell 62 included in the shortest avoidance path 70.

The blocked region detection unit 24 may detect a blocked region 76, which is a region that is not detected by the sensor unit 10 at the current position of the robot 50, based on the sensor data 68 received from the sensor unit 10 (e.g., occluded spaces behind walls, pillars, furniture, or sharp corners, etc.).

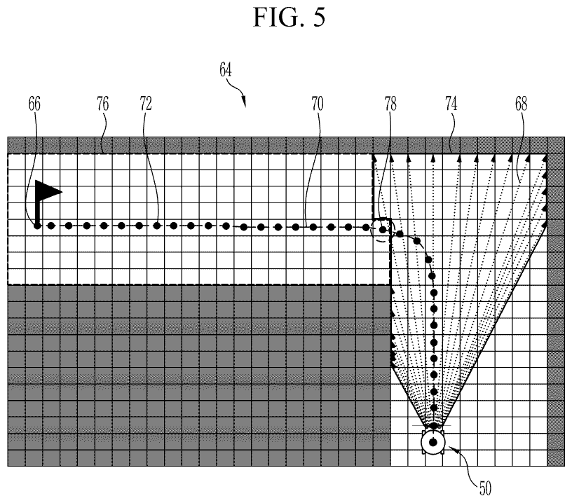

The corner entry point detection unit 30 may detect a candidate transition point (e.g., a corner entry point 78) by utilizing the shortest avoidance path 70 received from the shortest avoidance path generation unit 28 and the blocked region 76 received from the blocked region detection unit 24 (e.g., by identifying a transition from a sensor-detectable region to a blocked region along the path, etc.). A process of detecting the corner entry point 78 will be described in more detail below with reference to FIG. 5.

FIG. 5 shows exemplary detection of the corner entry point based on the shortest avoidance path of FIG. 4 (e.g., showing the relationship between visible and non-visible areas along the robot's path, etc.). In FIG. 5, a bold dotted line indicates the blocked region 76 and a bold solid line indicates a sensor detection region 74 (e.g., visually distinguishing areas within and outside the sensor's field of view, etc.). As illustrated in FIG. 5, the corner entry point detection unit 30 may check which region among the sensor detection region 74 and the blocked region 76 each node 72 included in the shortest avoidance path 70 belongs to (e.g., by sequentially evaluating sensor coverage at each node, etc.). For example, the corner entry point detection unit 30 may check which region among the sensor detection region 74 and the blocked region 76 all nodes 72 belong to sequentially from the current position of the robot 50 to the destination 66 (e.g., continuously evaluating visibility coverage for each path node, etc.). Then, the first node 72 that belongs to the sensor detection region 74 and then to the blocked region 76 is detected as the corner entry point 78 (e.g., identifying the transition point where the robot loses direct sensor visibility, etc.). In addition, it may be determined whether the corner entry point 78 is on the left side or the right side of the robot 50 to detect whether the robot 50 enters the corner by turning left or right (e.g., left-turn entry or right-turn entry, etc.). In the example of FIG. 5, the corner entry point 78 is positioned on the left side of the robot 50, so that it may be known that the robot 50 enters the corner by turning left.

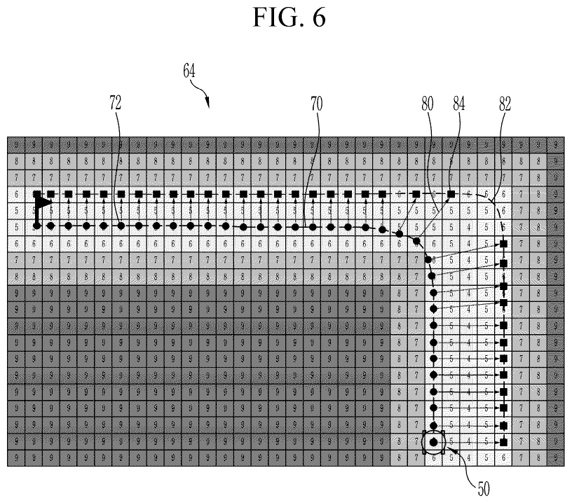

The turning region securing path generation unit 32 may generate a turning region securing path 82 based on the shortest avoidance path 70 received from the shortest avoidance path generation unit 28 (e.g., by expanding lateral clearance around the corner, etc.). Hereinafter, a process of generating the turning region securing path 82 will be described in more detail with reference to FIGS. 6 to 11.

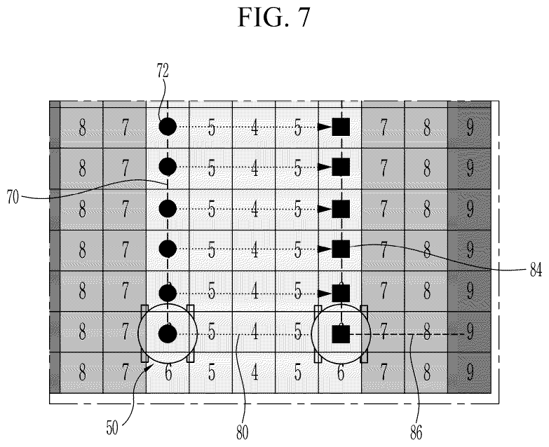

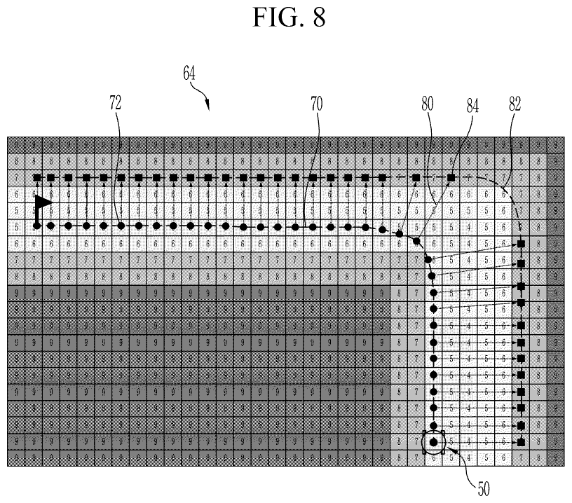

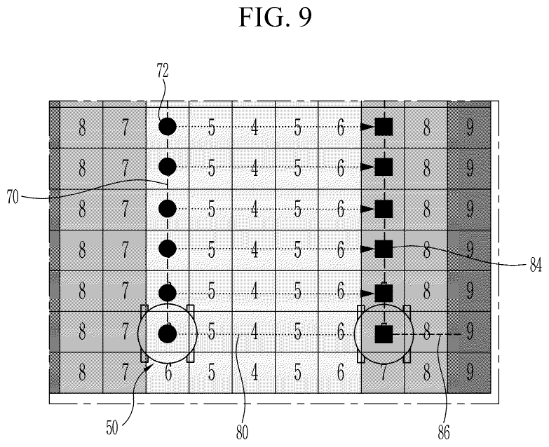

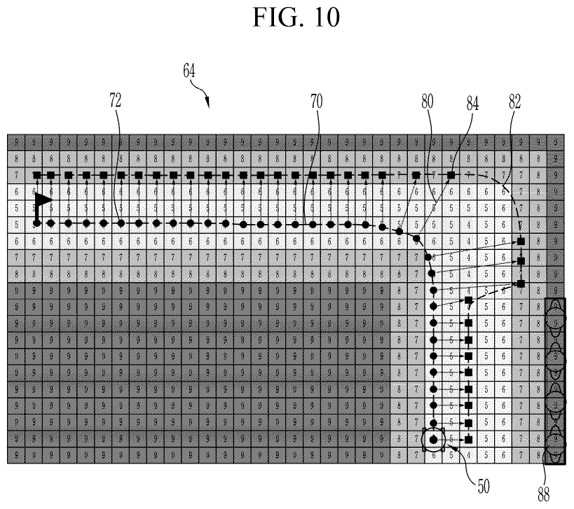

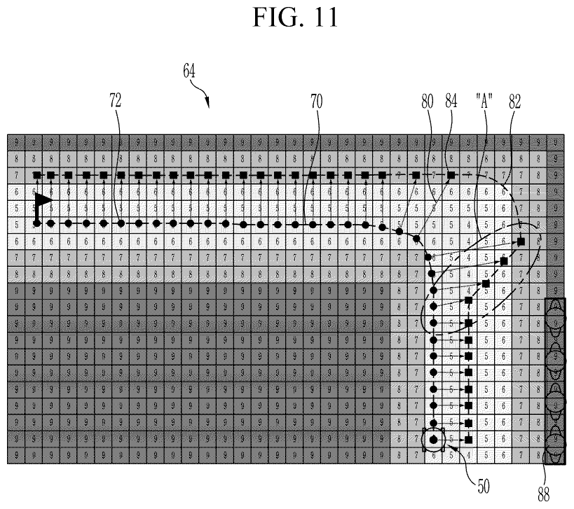

FIG. 6 shows exemplary generation of the turning region securing path based on the shortest avoidance path of FIG. 4 when a safety securing distance is three cells. FIG. 7 is a partially enlarged view of FIG. 6. FIG. 8 shows exemplary generation of the turning region securing path based on the shortest avoidance path of FIG. 4 when the safety securing distance is two cells. FIG. 9 is a partially enlarged view of FIG. 8. FIG. 10 shows exemplary generation of the turning region securing path based on the safety securing distance according to the type of the obstacle and the shortest avoidance path of FIG. 4. FIG. 11 shows exemplary generation of the turning region securing path by adjusting a search distance in FIG. 10 (e.g., dynamically controlling search distances based on previous node values, etc.). In FIGS. 6 to 11, circular dots represent the nodes 72 included in the shortest avoidance path 70, and square dots represent turning region securing nodes 84 included in the turning region securing path 82 (e.g., alternative candidate points for expanding lateral clearance, etc.).

As illustrated in FIGS. 6 to 11, the turning region securing path generation unit 32 may search for a turning region on the opposite side of a turning direction when entering the corner based on turning information received from the corner entry point detection unit 30 when entering the corner (e.g., left-turning at a right wall corner or right-turning at a left wall corner, etc.). For example, if a left turn is required when entering the corner, the turning region securing path generation unit 32 may search for the turning region on the right side based on the shortest avoidance path 70 (e.g., by expanding the path clearance toward the right side to ensure wider visibility and safer maneuvering, etc.), and if a right turn is required when entering the corner, the turning region securing path generation unit 32 may search for the turning region on the left side based on the shortest avoidance path 70 (e.g., by expanding the clearance toward the left side in anticipation of unseen obstacles, etc.).

More specifically, among directions orthogonal to a tangent line of the shortest avoidance path 70, the opposite side of the turning direction, when entering the corner, may be set as a search direction 80 of the turning region for each node 72 included in the shortest avoidance path 70 (e.g., +90 degrees relative to the local tangent direction, etc.). Thereafter, a point where the safety securing distance 86 may be secured within a preset search distance of the corresponding search direction 80 may be searched as the turning region securing node 84 by referring to the cost values of the cells 62 positioned in the search direction 80. The safety securing distance 86 may be preset or may vary depending on a property of the obstacle 88 (e.g., larger distance for pedestrians, smaller distance for fixed structures, etc.).

In one example, as illustrated in FIGS. 6 and 7, if a left turn is required when entering the corner and the safety securing distance 86 is three cells (in this example, it is assumed that the search distance is a preset maximum search distance which is sufficiently long), the turning region securing path generation unit 32 may search for, as the turning region securing node 84, a point that is three cells away from the cell 62 with the cost value of 9, which means the obstacle 88, on the right side of the shortest avoidance path 70, for each node 72 included in the shortest avoidance path 70, the three cells being the safety securing distance 86 e.g., maintaining sufficient clearance from walls, poles, or other fixed structures, etc.).

In another example, as illustrated in FIGS. 8 and 9, if a left turn is required when entering the corner and the safety securing distance 86 is two cells (in this example, it is assumed that the search distance is the preset maximum search distance which is sufficiently long), the turning region securing path generation unit 32 may search for, as the turning region securing node 84, a point that is two cells away from the cell 62 with the cost value of 9 on the right side of the shortest avoidance path 70, for each node 72 included in the shortest avoidance path 70, the two cells being the safety securing distance 86 (e.g., enabling tighter cornering suitable for narrow hallways, crowded indoor spaces, or dense obstacle areas, etc.). For example, compared to the examples illustrated in FIGS. 6 and 7, as the safety securing distance 86 is reduced by one cell, points that are one cell further in the search direction 80 may be searched as the turning region securing nodes 84.

FIG. 10 illustrates an example of searching for the turning region securing node 84 in a case where the safety securing distance 86 changes as the type of the obstacle changes (e.g., differentiating clearance distance depending on whether the obstacle is a human, wall, or moving object, etc.). In FIG. 10, it may be assumed that a left turn is required when entering the corner, the safety securing distance 86 for the obstacle 88 that is positioned on a lower right side and is a pedestrian is five cells (e.g., due to higher unpredictability and movement speed of pedestrians, etc.), the safety securing distance for the other obstacle 88 is three cells (e.g., for fixed structures such as walls, poles, or barriers, etc.), and the search distance is the preset maximum search distance which is sufficiently long. The turning region securing path generation unit 32 may search for, as the turning region securing node 84, a point that is five cells away from the cell 62 with the cost value of 9 on the right side of the shortest avoidance path 70 for the node 72 affected by the obstacle 88 that is the pedestrian, the five cells being the safety securing distance 86 (e.g., to maintain a wider berth from dynamic or vulnerable objects such as people, etc.), and may search for, as the turning region securing node 84, a point that is three cells away from the cell 62 with the cost value of 9 on the right side of the shortest avoidance path 70 for the node 72 affected by the other obstacle 88, the three cells being the safety securing distance 86 (e.g., for relatively static or less critical obstacles like walls or parked equipment, etc.).

In FIG. 10, since the search distance is not adjusted, a position of the turning region securing node 84 drastically changes in a region where the type of the obstacle 88 is changed in order to have a different safety securing distance (e.g., sudden shifts in the turning path near transitions between different obstacle types, etc.). FIG. 11 illustrates an example of searching for the turning region securing node 84 in a case where the search distance is adjusted in a region A where the type of the obstacle 88 is changed in order to have a different safety securing distance (e.g., smoothing the turning path by gradually adjusting lateral offsets, etc.). When entering the corner in FIG. 11, the type, the position, and the safety securing distance 86 of the obstacle 88, and the turning direction may be the same as those in FIG. 10 when entering the corner (e.g., maintaining consistent environmental conditions to focus on the effects of search distance adjustment, etc.). However, in FIG. 11, in the region A where the type of the obstacle 88 is changed, the search distance may be adjusted as in Equation 1, so that the position of the turning region securing node 84 changes more smoothly (e.g., avoiding abrupt deviations in the robot's path, improving path continuity, etc.).

$$[ Equation 1 ]$$

$$Search Distance from Current Node = min ( Search Distance from Prevous Node + α Cells ; \text{} Preset Maximum Search Distance )$$

Here, α may be any preset natural number (e.g., 1, 2, or 3, depending on desired path smoothness, etc.). For example, α may be 1, but is not limited thereto.

The turning region securing path generation unit 32 may perform the search for the turning region securing node 84 for all the nodes 72 included in the shortest avoidance path 70 through the above process, and generate a set of all the turning region securing nodes 84 as the turning region securing path 82 (e.g., forming a new candidate path maintaining sufficient clearance along the turn, etc.).

The weight value determination unit 34 may be configured to determine a weight value for determining a final path 92 between the shortest avoidance path 70 and the turning region securing node 84 (e.g., balancing between minimal distance and improved safety margin, etc.). The weight value determination unit 34 may determine the weight value such that the robot 50 smoothly drives from the current position to a point away from the corner, makes a large turn, and then smoothly drives to the destination 66 (e.g., without abrupt heading changes or unnecessary stops, etc.).

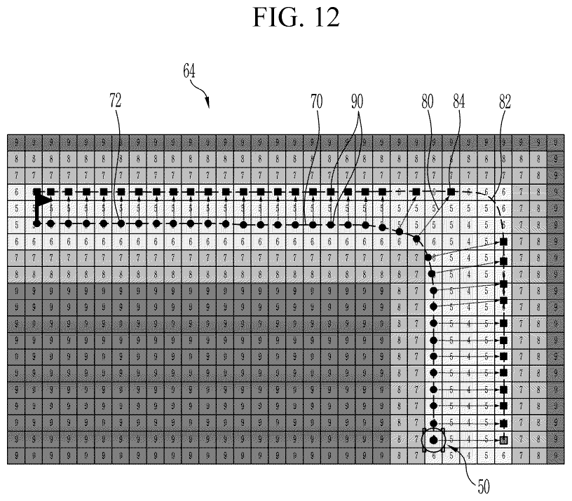

FIG. 12 shows an example of determining the weight value based on the turning region securing path of FIG. 6. In FIG. 12, circular dots represent the nodes 72 included in the shortest avoidance path 70 (e.g., original nodes optimized for minimal distance travel, etc.), and square dots represent the turning region securing nodes 84 included in the turning region securing path 82 (e.g., nodes selected to provide increased lateral clearance near corners, etc.). In order for the robot 50 to smoothly drive from the current position to the point away from the corner, assignment of the weight value needs to be performed such that the weight value for the turning region securing path 82 gradually increases as the distance from the current position of the robot 50 increases (e.g., progressively biasing the robot's trajectory toward the widened turning path to enhance cornering safety, etc.), and in order for the robot 50 to drive smoothly to the destination 66, the assignment of the weight value needs to be performed such that the weight value for the turning region securing path 82 gradually decreases as the distance to the destination 66 decreases (e.g., creating a smooth interpolation between wide turns and direct paths, etc.).

In one example, as illustrated in FIG. 12, the weight value determination unit 34 may select center points of the shortest avoidance path 70 and the turning region securing path 82 as a peak point pair 90 (e.g., points approximately halfway between the start and the destination, etc.), and may assign a weight value of 1 to the turning region securing path 82 at the peak point pair 90 (e.g., prioritizing maximum clearance at the midpoint, etc.). In addition, the weight value determination unit 34 may linearly increase the weight value for the turning region securing path 82 from 0 at the current position of the robot 50 to 1 at the peak point pair 90, and linearly decrease the weight value back to 0 at the destination 66 (e.g., creating a smooth weight transition that supports wide turning at the center, etc.). On the other hand, the weight value determination unit 34 may linearly decrease the weight value for the shortest avoidance path 70 from 1 at the current position of the robot 50 to 0 at the peak point pair 90, and linearly decrease the weight value back to 1 at the destination 66 (e.g., enabling gradual blending between direct and widened paths, etc.). Table 1 shows one example of the weight values assigned to the node 72 and the turning region securing node 84 (e.g., demonstrating a smooth transition of influence between the original and widened paths, etc.). In Table 1, a number of a node corresponding to the current position of the robot 50 is set to 0, a number of a node corresponding to the destination 66 is set to 34 (e.g., indicating the contribution of the wide-turn path at each position, etc.), w1 is a weight value assigned to the turning region securing node 84, and w2 is a weight value assigned to the node 72 (e.g., indicating the contribution of the shortest avoidance path at each position, etc.).

TABLE 1

| Node | | |
|---|---|---|
| Number | w 1 | w 2 |
| 0 | 0/17 | 17/17 |
| 1 | 1/17 | 16/17 |
| 2 | 2/17 | 15/17 |
| 3 | 3/17 | 14/17 |
| 4 | 4/17 | 13/17 |
| 5 | 5/17 | 12/17 |
| 6 | 6/17 | 11/17 |
| 7 | 7/17 | 10/17 |
| 8 | 8/17 | 9/17 |
| 9 | 9/17 | 8/17 |
| 10 | 10/17 | 7/17 |
| 11 | 11/17 | 6/17 |
| 12 | 12/17 | 5/17 |
| 13 | 13/17 | 4/17 |
| 14 | 14/17 | 3/17 |
| 15 | 15/17 | 2/17 |
| 16 | 16/17 | 1/17 |
| 17 | 17/17 | 0/17 |
| 18 | 16/17 | 1/17 |
| 19 | 15/17 | 2/17 |
| 20 | 14/17 | 3/17 |
| 21 | 13/17 | 4/17 |
| 22 | 12/17 | 5/17 |
| 23 | 11/17 | 6/17 |
| 24 | 10/17 | 7/17 |
| 25 | 9/17 | 8/17 |
| 26 | 8/17 | 9/17 |
| 27 | 7/17 | 10/17 |
| 28 | 6/17 | 11/17 |
| 29 | 5/17 | 12/17 |
| 30 | 4/17 | 13/17 |
| 31 | 3/17 | 14/17 |
| 32 | 2/17 | 15/17 |
| 33 | 1/17 | 16/17 |
| 34 | 0/17 | 17/17 |

In another example, the weight value determination unit 34 may select the node 72 closest to the corner and the corresponding turning region securing node 84 as the peak point pair 90 (e.g., to prioritize wide turning exactly at the corner approach, etc.), assign a weight value of 1 to the turning region securing path 82 at the peak point pair 90, assign a weight value of 0 to the turning region securing path 82 at the current position of the robot 50 and the destination 66, linearly increase the weight value for the turning region securing path 82 from the current position of the robot 50 to the peak point pair 90, and linearly decrease the weight value for the turning region securing path 82 from the peak point pair 90 to the destination 66 (e.g., to ensure the robot smoothly reverts back to a direct path after completing the corner, etc.).

In another example, in a case where a distance between the robot 50 and the corner entry point 78 is relatively short, the weight value determination unit 34 may determine the weight value such that the robot 50 enters the turning region securing path 82 more quickly (e.g., favoring a faster transition into wide turning when a corner is nearby, etc.), and in a case where the distance between the robot 50 and the corner entry point 78 is relatively long, the weight value determination unit 34 may determine the weight value such that the robot 50 enters the turning region securing path 82 more slowly (e.g., allowing a more gradual adaptation when the corner is farther away, etc.).

The path interpolation unit 36 may be configured to interpolate the shortest avoidance path 70 and the turning region securing path 82 by using the weight values determined by the weight value determination unit 34 to generate an interpolation path 92 (e.g., creating a blended path that dynamically adjusts between direct and widened trajectories, etc.). The interpolation path 92 may be generated by Equation 2 (e.g., a weighted blending formula to generate a smooth and adaptive transition path, etc.).

$${Path}_{interpolation} = w 1 * {path}_{turning} + w 2 * {path}_{shortest} \qquad [ Equation 2 ]$$

Here, Pathᵢₙₜₑᵣₚₒₗₐₜᵢₒₙ represents an interpolation path 92, path_{turning} represents the turning region securing path 82, pathₛₕₒᵣₜₑₛₜ represents the shortest avoidance path 70, w1 is the weight value for the turning region securing path 82, and w2 is the weight value for the shortest avoidance path 70 (e.g., dynamically adjusting influence between widened and direct paths at each node, etc.). For example, all interpolation nodes 94 may be determined by applying Equation 2 to all pairs of the nodes 72 and the corresponding turning region securing nodes 84, and a set of all the interpolation nodes 94 may be generated as the interpolation path 92 (e.g., resulting in a flexible and context-sensitive driving trajectory, etc.).

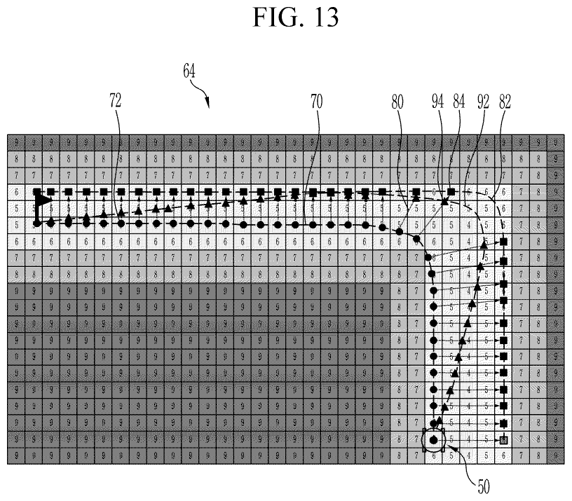

FIG. 13 shows exemplary generation of the interpolation path based on the weight value determined in FIG. 12. Referring to FIG. 13, since w1=0 and w2=1 at the current position of the robot 50 and the destination 66, the corresponding interpolation node 94 may coincide with the node 72 on the shortest avoidance path 70 (e.g., when full reliance on the shortest avoidance path is preferred, etc.), and since w1=1 and w2=0 at the peak point pair 90, the corresponding interpolation node 94 may coincide with the turning region securing node 84 on the turning region securing path 82 (e.g., when full reliance on the widened path is preferred near the corner, etc.). Accordingly, the interpolation path 92 that makes a large turn around the corner may be generated (e.g., improving visibility and collision avoidance at blind spots, etc.).

The path selection unit 38 may select, as the final path, one of the shortest avoidance path 70 received from the shortest avoidance path generation unit 28 and the interpolation path 92 received from the path interpolation unit 36 (e.g., based on real-time assessment of safety needs, etc.). In general, the path selection unit 38 may select the interpolation path 92 as the final path such that the robot 50 may avoid collision with the obstacle and make the large turn around the corner, but in a special case where there is no object approaching the corner from the opposite side of the corner, the path selection unit 38 may select the shortest avoidance path 70 as the final path (e.g., to minimize or reduce travel time and energy usage when no wide turn is necessary, etc.).

The path following unit 40 may control driving and steering of the robot 50 such that the robot 50 follows the final path transmitted from the path selection unit 38 (e.g., executing velocity and steering commands to stay aligned with the path, etc.).

The robot 50 may include at least an energy storage device and a robot driving unit 52, and the robot driving unit 52 may receive power from the energy storage device and drive the robot 50 such that the robot 50 follows the final path under the control of the controller 20, particularly under the control of the path following unit 40 (e.g., ensuring coordinated propulsion and steering to accurately track the planned trajectory, etc.). The robot driving unit 52 may include, but is not limited to, at least one wheel and at least one drive motor connected to the at least one wheel and rotating the at least one wheel (e.g., front-wheel drive, rear-wheel drive, or all-wheel drive configurations, etc.). The robot driving unit 52 may further include a steering device for steering the robot 50 (e.g., a rack-and-pinion steering mechanism or an independent actuator-based steering system, etc.).

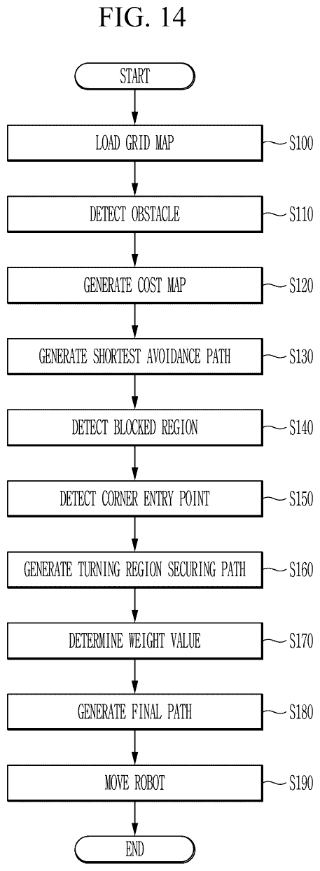

Hereinafter, the real-time path generation method for corner turning of the robot according to another example of the present disclosure will be described with reference to FIG. 14 (e.g., outlining step-by-step operations of the system for dynamic corner navigation, etc.). FIG. 14 shows an example of the real-time path generation method for corner turning of the robot according to another example of the present disclosure (e.g., showing the sequential execution of key processing modules, etc.).

As illustrated in FIG. 14, the real-time path generation method for corner turning of the robot according to another example of the present disclosure may start at step S100. In order to perform the step S100, the sensor unit 10 may detect the sensor data 68 within the field of view and transmit the detected sensor data 68 to the controller 20 (e.g., data from LiDAR, cameras, ultrasonic sensors, or radar, etc.).

The cost map generation unit 26 may load the grid map stored in the controller 20 at the step S100, and the obstacle detection unit 22 of the controller may detect the obstacle based on the sensor data 68 at step S110 (e.g., identifying objects such as pedestrians, walls, or pillars in the environment, etc.). An execution order of the steps S100 and S110 is not limited to the illustrated order (e.g., steps may run concurrently or in reverse sequence based on system optimization, etc.).

When the grid map is loaded and the obstacle 88 is detected, the cost map generation unit 26 may generate the occupancy grid map 60 based on the grid map and the obstacle information, and generate the cost map 64 for the surroundings of the robot 50 based on the occupancy grid map 60 and the obstacle information at step S120 (e.g., producing a cost field for safe navigation planning, etc.).

When the cost map 64 is generated, the shortest avoidance path generation unit 28 may generate the shortest avoidance path 70 along which the destination 66 may be reached from the current position of the robot 50 while avoiding the obstacle by using the path generation algorithm based on the cost map 64 at step S130 (e.g., using an A or Dijkstra's algorithm to minimize or reduce path cost while maintaining obstacle clearance, etc.).

The blocked region detection unit 24 of the controller 20 may detect the blocked region 76, which is the region not detected by the sensor unit 10 at the current position of the robot 50, based on the sensor data 68 at step S140 (e.g., blind spots behind obstacles like walls, furniture, or pillars, etc.), and the corner entry point detection unit 30 may detect the corner entry point 78 by utilizing the shortest avoidance path 70 received from the shortest avoidance path generation unit 28 and the blocked region 76 received from the blocked region detection unit 24 at step S150 (e.g., determining where the robot begins transitioning into an area of reduced visibility, etc.).

When the corner entry point 78 is detected, the turning region securing path generation unit 32 may generate the turning region securing path 82 based on the shortest avoidance path 70 at step S160 (e.g., adapting the original path to ensure sufficient clearance around blind spots, etc.). More specifically, the turning region securing path generation unit 32 may set, as the search direction 80 of the turning region for each node 72 included in the shortest avoidance path 70, the opposite side of the turning direction when entering the corner among directions orthogonal to the tangent line of the shortest avoidance path 70 (e.g., ±90 degrees relative to the heading at each node, etc.). Thereafter, the turning region securing path generation unit 32 may search for, as the turning region securing node 84, the point where the safety securing distance 86 may be secured within the preset search distance of the corresponding search direction 80 by referring to the cost values of the cells 62 positioned in the search direction 80 (e.g., searching grid cells laterally until a safe gap is found, etc.). The safety securing distance 86 may be preset or may vary depending on the property of the obstacle 88 (e.g., larger for pedestrians, smaller for walls or static objects, etc.). Then, the turning region securing path generation unit 32 may perform the search for the turning region securing node 84 for all the nodes 72 included in the shortest avoidance path 70 through the above process, and generate the set of all the turning region securing nodes 84 as the turning region securing path 82 (e.g., building a secondary path optimized or enhanced for wide turning motion, etc.).

When the turning region securing path 82 is generated, the weight value determination unit 34 may determine the weight value for determining the final path 92 between the shortest avoidance path 70 and the turning region securing path 82 at step S170 (e.g., assigning blending factors for smooth transition between paths, etc.). In one example, at the step S170, the weight value determination unit 34 may assign the weight value such that the weight value for the turning region securing path 82 gradually increases and the weight value for the shortest avoidance path 70 gradually decreases as the distance from the current position of the robot 50 increases (e.g., progressively favoring the wide-turn path to ensure sufficient clearance as the robot approaches the corner, etc.) in order for the robot 50 to smoothly drive to the point away from the corner from the current position, and may assign the weight value such that the weight value for the turning region securing path 82 gradually decreases and the weight value for the shortest avoidance path 70 gradually increases as the distance to the destination 66 decreases in order for the robot 50 to smoothly drive to the destination 66 (e.g., forming a bell-shaped influence curve centered at the corner, etc.).

When the weight values are assigned to the shortest avoidance path 70 and the turning region securing path 82, the path interpolation unit 36 may interpolate the shortest avoidance path 70 and the turning region securing path 82 by using the weight values determined by the weight value determination unit 34 to generate the interpolation path 92 (e.g., producing a blended path that adapts between narrow and wide trajectories, etc.). And the path selection unit 38 may select one of the shortest avoidance path 70 received from the shortest avoidance path generation unit 28 and the interpolation path 92 received from the path interpolation unit 36 as the final path (e.g., choosing the most appropriate path based on corner conditions and obstacle presence, etc.), thereby generating the final path at step S180.

Then, the path following unit 40 may control the driving and steering of the robot 50 to move the robot 50 such that the robot 50 follows the final path received from the path selection unit 38 at step S190 (e.g., by issuing motor commands to regulate speed and steering angles based on the selected path, etc.).

A real-time path generation method for corner turning of a robot according to an example of the present disclosure includes: generating, by a controller, a cost map for surroundings of the robot based on a grid map and information regarding an obstacle detected by a sensor unit; generating, by the controller, a shortest avoidance path along which a destination is reachable from a current position of the robot while avoiding the obstacle based on the cost map; detecting, by the controller, a blocked region which is a region not detected by the sensor unit at the current position of the robot; detecting, by the controller, a corner entry point using the shortest avoidance path and the blocked region; generating, by the controller, a turning region securing path based on the shortest avoidance path and based on the corner entry point; determining, by the controller, weight values for the shortest avoidance path and the turning region securing path; generating, by the controller, an interpolation path based on the shortest avoidance path, the turning region securing path, and the weight values; and generating, by the controller, a final path based on the shortest avoidance path and the interpolation path.

The detecting a corner entry point using the shortest avoidance path and the blocked region may include: checking which region among the sensor detection region and the blocked region all nodes included in the shortest avoidance path belong to sequentially from the current position of the robot to the destination; detecting a first node that belongs to the sensor detection region and then to the blocked region as the corner entry point; and detecting a turning direction when entering a corner.

The generating a turning region securing path based on the shortest avoidance path may include: determining a search direction of a turning region based on the turning direction when entering the corner; and searching for, as a turning region securing node, a point where a safety securing distance is secured within a search distance in the search direction for all nodes included in the shortest avoidance path sequentially from the current position of the robot to the destination, and the safety securing distance may be a distance to be separated from the obstacle.

Among directions orthogonal to a tangent line of the shortest avoidance path, an opposite side of the turning direction when entering the corner may be determined as the search direction of the turning region for each node included in the shortest avoidance path.

The safety securing distance may be preset or may vary depending on a property of the obstacle.

The search distance may be a preset maximum search distance.

The search distance from a current node may be determined by the following equation.

$$Search Distance from Current Node = min ( Search Distance from Prevous Node + α Cells ; \text{} Preset Maximum Search Distance )$$

Here, α may be any preset natural number.

The determining weight values for the shortest avoidance path and the turning region securing path may include: selecting a peak point pair of the shortest avoidance path and the turning region securing path; assigning a weight value of 1 to the turning region securing path and assigning a weight value of 0 to the shortest avoidance path at the peak point pair; assigning a weight value of 0 to the turning region securing path and assigning a weight value of 1 to the shortest avoidance path at the current position of the robot and the destination; increasing the weight value for the turning region securing path and decreasing the weight value for the shortest avoidance path from the current position of the robot to the peak point pair; and decreasing the weight value for the turning region securing path and increasing the weight value for the shortest avoidance path from the peak point pair to the destination.

The peak point pair of the shortest avoidance path and the turning region securing path may be selected as center points of the shortest avoidance path and the turning region securing path or as the corner entry point and a point of the turning region securing path that corresponds to the corner entry point.

The interpolation path (Pathᵢₙₜₑᵣₚₒₗₐₜᵢₒₙ) may be generated by the following equation.

$${Path}_{interpolation} = w 1 * {path}_{turning} + w 2 * {path}_{shortest}$$

Here, path_{turning} may represent the turning region securing path, pathₛₕₒᵣₜₑₛₜ may represent the shortest avoidance path, w1 may be the weight value for the turning region securing path, and w2 may be the weight value for the shortest avoidance path.

A real-time path generation system for corner turning of a robot according to another example of the present disclosure includes: a sensor unit configured to detect sensor data within a field of view; and a controller configured to receive the sensor data from the sensor unit, generate a path from a current position of the robot to a destination, and control the robot to move according to the generated path, in which the controller is configured to generate a cost map for surroundings of the robot based on a grid map and the sensor data received from the sensor unit, generate a shortest avoidance path along which the destination is reachable from the current position of the robot while avoiding an obstacle based on the cost map, detect a blocked region which is a region not detected by the sensor unit at the current position of the robot, detect a corner entry point using the shortest avoidance path and the blocked region, generate a turning region securing path based on the shortest avoidance path and based on the corner entry point, determine weight values for the shortest avoidance path and the turning region securing path, generate an interpolation path based on the shortest avoidance path, the turning region securing path, and the weight values, and generate a final path based on the shortest avoidance path and the interpolation path.

When detecting the corner entry point using the shortest avoidance path and the blocked region, the controller may be configured to check which region among the sensor detection region and the blocked region all nodes included in the shortest avoidance path belong to sequentially from the current position of the robot to the destination, detect a first node that belongs to the sensor detection region and then to the blocked region as the corner entry point, and detect a turning direction when entering a corner.

When generating the turning region securing path based on the shortest avoidance path, the controller may be configured to determine a search direction of a turning region based on the turning direction when entering the corner, and search for, as a turning region securing node, a point where a safety securing distance is secured within a search distance in the search direction for all nodes included in the shortest avoidance path sequentially from the current position of the robot to the destination, and the safety securing distance may be a distance to be separated from the obstacle.

The controller may be configured to determine, as the search direction of the turning region for each node included in the shortest avoidance path, an opposite side of the turning direction when entering the corner among directions orthogonal to a tangent line of the shortest avoidance path.

The safety securing distance may be preset or may vary depending on a property of the obstacle.

The search distance may be a preset maximum search distance.

The controller may determine the search distance from a current node by the following equation.

$$Search Distance from Current Node = min ( Search Distance from Prevous Node + α Cells ; \text{} Preset Maximum Search Distance )$$

Here, α may be any preset natural number.

When determining the weight values for the shortest avoidance path and the turning region securing path, the controller may be configured to select a peak point pair of the shortest avoidance path and the turning region securing path, assign a weight value of 1 to the turning region securing path and assign a weight value of 0 to the shortest avoidance path at the peak point pair, assign a weight value of 0 to the turning region securing path and assign a weight value of 1 to the shortest avoidance path at the current position of the robot and the destination, increase the weight value for the turning region securing path and decrease the weight value for the shortest avoidance path from the current position of the robot to the peak point pair, and decrease the weight value for the turning region securing path and increase the weight value for the shortest avoidance path from the peak point pair to the destination.

The controller may select the peak point pair of the shortest avoidance path and the turning region securing path as center points of the shortest avoidance path and the turning region securing path or as the corner entry point and a point of the turning region securing path that corresponds to the corner entry point.

The controller may generate the interpolation path (Pathᵢₙₜₑᵣₚₒₗₐₜᵢₒₙ) by the following equation.

$${Path}_{interpolation} = w 1 * {path}_{turning} + w 2 * {path}_{shortest}$$

Here, path_{turning} may represent the turning region securing path, pathₛₕₒᵣₜₑₛₜ may represent the shortest avoidance path, w1 may be the weight value for the turning region securing path, and w2 may be the weight value for the shortest avoidance path.

According to the present disclosure, a real-time path that may make a large turn around a corner may be generated, so that safety for an object approaching from the opposite side of the corner, which is a region that is difficult to detect in advance with a sensor, may be secured.

It is possible to generate a path that avoids collision with obstacles and makes a large turn around a corner at the same time based on real-time obstacle information. Therefore, it is possible to flexibly cope with an unstructured environment that changes from moment to moment, and to provide a safer and smarter service.

While the present disclosure has been described in connection with what is presently considered to be practical examples, it is to be understood that the present disclosure is not limited to the disclosed examples. On the contrary, it is intended to cover various modifications and equivalent arrangements included within the spirit and scope of the appended claims.

What is claimed:

1. A method performed by an apparatus of a robot, the method comprising:
based on a grid map and information regarding an obstacle detected by a sensor of the robot, generating a cost map for surrounding areas of the robot, wherein the surrounding areas are within a threshold distance from the robot;
generating, based on the cost map, a shortest avoidance path from a current position of the robot to a destination such that the shortest avoidance path bypasses the obstacle;
detecting a blocked region that is outside a sensing range of the sensor at the current position of the robot;
detecting, based on the shortest avoidance path and the blocked region, a corner entry point;
generating, based on the shortest avoidance path and the corner entry point, a turning region securing path;
determining weight values for the shortest avoidance path and the turning region securing path;
generating an interpolation path, wherein the interpolation path is based on the shortest avoidance path, the turning region securing path, and the weight values;
generating, based on the shortest avoidance path and the interpolation path, a final path;
outputting a signal indicating the final path; and
controlling, based on the signal, driving of the robot.

2. The method of claim 1, wherein the detecting the corner entry point comprises:
checking, for each node included in the shortest avoidance path sequentially from the current position of the robot to the destination, whether the node belongs to a sensor detection region or a blocked region;
identifying, as the corner entry point, a first node that transitions from the sensor detection region to the blocked region; and
detecting a turning direction associated with entering a corner.

3. The method of claim 2, wherein the generating the turning region securing path comprises:
determining, based on the turning direction, a search direction of a turning region; and
searching, for each node included in the shortest avoidance path sequentially from the current position of the robot to the destination, for a point in the search direction where a safety securing distance is satisfied within a search distance, and setting the point as a turning region securing point,
wherein the safety securing distance is a distance to be separated from the obstacle.

4. The method of claim 3, wherein the determining the search direction comprises, for each node included in the shortest avoidance path, determining the search direction as a direction opposite to the turning direction when entering the corner, the direction being among directions orthogonal to a tangent line of the shortest avoidance path.

5. The method of claim 3, wherein the safety securing distance is preset or varies based on a property of the obstacle.

6. The method of claim 3, wherein the search distance is a preset maximum search distance.

7. The method of claim 3, wherein the search distance from a current node is determined based on a sum of a preset number of cells and a previous search distance from a previous node,
wherein the preset number of cells is a natural number, and
wherein the sum is limited so as not to exceed a preset maximum search distance.

8. The method of claim 1, wherein the determining the weight values comprises:
selecting a peak point on the shortest avoidance path and a corresponding peak point on the turning region securing path;
assigning a weight value of 1 to the corresponding peak point on the turning region securing path and assigning a weight value of 0 to the peak point on the shortest avoidance path;
assigning a weight value of 0 to a node of the turning region securing path at the current position of the robot and to a node of the turning region securing path at the destination, and assigning a weight value of 1 to a node of the shortest avoidance path at the current position of the robot and to a node of the shortest avoidance path at the destination;
assigning, to nodes along the turning region securing path, weight values that increase from 0 at the current position of the robot to 1 at the corresponding peak point and weight values that decrease from 1 at the corresponding peak point to 0 at the destination; and
assigning, to nodes along the shortest avoidance path, weight values that decrease from 1 at the current position of the robot to 0 at the peak point and weight values that increase from 0 at the peak point to 1 at the destination.

9. The method of claim 8, wherein the peak point on the shortest avoidance path and the corresponding peak point on the turning region securing path are selected as:
a center point of the shortest avoidance path and a center point of the turning region securing path, respectively; or
the corner entry point and a corresponding entry point on the turning region securing path, respectively.

10. The method of claim 1, wherein the interpolation path is generated based on a sum of:
a weighted path value associated with the turning region securing path, and
a weighted path value associated with the shortest avoidance path.

11. An apparatus of a robot, the apparatus comprising:
a processor; and
a memory storing at least one instruction that, when executed by the processor communicating with the memory, is configured to cause the apparatus to:
detect, using a sensor of the robot, sensor data within a field of view of the sensor; and
based on a grid map and the sensor data, generate a cost map for surrounding areas of the robot, wherein the surrounding areas are within a threshold distance from the robot,
generate, based on the cost map, a shortest avoidance path from a current position of the robot to a destination such that the shortest avoidance path bypasses an obstacle,
detect a blocked region that is outside the field of view at the current position of the robot,
detect, based on the shortest avoidance path and the blocked region, a corner entry point,
generate, based on the shortest avoidance path and the corner entry point, a turning region securing path,
determine weight values for the shortest avoidance path and the turning region securing path,
generate an interpolation path, wherein the interpolation path is based on the shortest avoidance path, the turning region securing path, and the weight values, and
generate, based on the shortest avoidance path and the interpolation path, a final path,
output a signal indicating the final path, and
control, based on the signal, movements of the robot.

12. The apparatus of claim 11, wherein the at least one instruction, when executed by the processor communicating with the memory, is configured to cause the apparatus to detect the corner entry point by:
checking, for each node included in the shortest avoidance path sequentially from the current position of the robot to the destination, whether the node belongs to a sensor detection region or a blocked region,
identifying, as the corner entry point, a first node that transitions from the sensor detection region to the blocked region, and
detecting a turning direction associated with entering a corner.

13. The apparatus of claim 12, wherein the at least one instruction, when executed by the processor communicating with the memory, is configured to cause the apparatus to generate the turning region securing path by:
determining, based on the turning direction, a search direction of a turning region, and
searching, for each node included in the shortest avoidance path sequentially from the current position of the robot to the destination, for a point in the search direction where a safety securing distance is satisfied within a search distance, and setting the point as a turning region securing point,
wherein the safety securing distance is a distance to be separated from the obstacle.

14. The apparatus of claim 13, wherein the at least one instruction, when executed by the processor communicating with the memory, is configured to cause the apparatus to, for each node included in the shortest avoidance path, determine the search direction as a direction opposite to the turning direction when entering the corner, the direction being among directions orthogonal to a tangent line of the shortest avoidance path.

15. The apparatus of claim 13, wherein the safety securing distance is preset or varies based on a property of the obstacle.

16. The apparatus of claim 13, wherein the search distance is a preset maximum search distance.

17. The apparatus of claim 13, wherein the at least one instruction, when executed by the processor communicating with the memory, is configured to cause the apparatus to determine the search distance from a current node based on a sum of a preset number of cells and a previous search distance from a previous node,
wherein the preset number of cells is a natural number, and
wherein the sum is limited so as not to exceed a preset maximum search distance.

18. The apparatus of claim 11, wherein the at least one instruction, when executed by the processor communicating with the memory, is configured to cause the apparatus to determine the weight values by:
selecting a peak point on the shortest avoidance path and a corresponding peak point on the turning region securing path,
assigning a weight value of 1 to the corresponding peak point on the turning region securing path and assigning a weight value of 0 to the peak point on the shortest avoidance path,
assigning a weight value of 0 to a node of the turning region securing path at the current position of the robot and to a node of the turning region securing path at the destination, and assigning a weight value of 1 to a node of the shortest avoidance path at the current position of the robot and to a node of the shortest avoidance path at the destination,
assigning, to nodes along the turning region securing path, weight values that increase from 0 at the current position of the robot to 1 at the corresponding peak point and weight values that decrease from 1 at the corresponding peak point to 0 at the destination; and
assigning, to nodes along the shortest avoidance path, weight values that decrease from 1 at the current position of the robot to 0 at the peak point and weight values that increase from 0 at the peak point to 1 at the destination.

19. A method performed by an apparatus of a vehicle, the method comprising:
receiving spatial data representing an environment of the vehicle, including information associated with obstacles;
generating, based on the spatial data, a path from a current position of the vehicle to a destination;
identifying a region with limited sensing coverage relative to a sensor of the vehicle;
determining, based on the path and the region, a candidate transition point;
generating, based on the candidate transition point and the information associated with the obstacles, a secondary path;
determining respective weight values for the path and the secondary path;
generating an interpolated path, wherein the interpolated path is based on the path, the secondary path, and the weight values; and
outputting, based on the interpolated path, a signal indicating a final path; and
controlling, based on the signal, autonomous driving of the vehicle.

20. The method of claim 19, wherein the generating of the secondary path comprises adjusting a spacing distance from at least one of the obstacles based on a property of the at least one of the obstacles, and wherein the vehicle comprises a robot.
